(19) United States
(12) Patent Application Publication
(10) Pub. No.: US 2006/0103124 A1
(43) Pub. Date: May 18, 2006

(54) Airbag module having a gas generator

(76) Inventor: Thomas Marotzke, Bergfelde (DE)

Correspondence Address: FOLEY AND LARDNER LLP;SUITE 500, 3000 K STREET NW, WASHINGTON, DC, 20007, US

(21) Appl. No.: 10/524,816

(22) PCT Filed: Aug. 19, 2003
(86) PCT No.: PCT/DE03/02834

§ 371 Date: Aug. 30, 2005

(30) Foreign Application Priority Data
Aug. 20, 2002 (DE) 102 38 842.3

(51) Int. Cl. B60R 21/217; B60R 21/26

(52) U.S. Cl. 280/740; 280/736; 280/728.2

(57) ABSTRACT

The invention relates to an airbag module having a gas generator, particularly a tubular gas generator, comprising a number of outflow openings, which are distributed over the circumference thereof and provided for gases produced after it has been triggered. The invention provides that at least one of the outflow openings inside the gas generator can be closed during installation or after installation in the airbag module, and that the gas generator is fixed inside a module housing that has a closing element in the area of each opening of the gas generator to be closed.

The invention relates to an airbag module having a gas generator according to the precharacterizing clause of claim 1.

Gas generators for airbag modules, which have a plurality of outflow openings from which the gases necessary for the deployment of the airbag emerge after the gas generator has been triggered, are known. For safety reasons, the outflow openings are arranged in such a manner that the gas generator, if inadvertently triggered before its installation, operates in a thrust-free manner, i.e. does not act in the manner of a rocket engine. The outflow openings therefore have to be distributed uniformly over the circumference of the gas generator.

After the installation of the gas generator into the airbag module, the gases, however, are to flow in the direction of the airbag, i.e. they have to be deflected, since they flow out of the gas generator in different directions. An annular gap between the gas generator and the module housing or a diffuser, as is known, for example, from DE 195 06 886 A1 or U.S. Pat. No. 6,126,195, is therefore provided in the airbag module. The gases produced in the gas generator are collected in the annular gap and directed with the aim of achieving a good deployment of the airbag.

The disadvantage of these arrangements is that the overall size of the airbag module is increased by the annular gap and gas gaps around the gas generator. Furthermore, the housing of the airbag module, due to large, projected surfaces, is exposed to a high mechanical stress by the gas pressure when the gas generator is triggered. The module therefore has to have great strength. It is thus necessary, for example, for many screws to be used. The high strength that is required results in an increased weight. Furthermore, energy is lost because of the deflection of the gas and, due to leakages in the module housing, there is the risk of gas being lost.

U.S. Pat. No. 5,480,185 discloses a gas generator which has only one outflow opening in the direction of a diffuser. This gas generator can therefore not operate in a thrust-free manner before the installation and therefore does not meet the stringent safety requirements. Furthermore, an adaptation to particular arrangements of the airbag is not possible with this gas generator. The additionally arranged diffuser causes additional costs.

The invention is based on the object, in the case of an airbag module having a gas generator, which has a plurality of outflow openings distributed over its circumference, in particular at least two opposite outflow openings, of avoiding the annular gap.

The object is achieved according to the invention by the features of claim 1.

In the case of an airbag module having a gas generator, in particular having a tubular gas generator, which has a plurality of outflow openings distributed over its circumference for the gases produced after it has been triggered, according to the invention at least one of the outflow openings in the gas generator can be closed during the installation or after the installation in the airbag module, and the gas generator is fastened in a module housing which has a closure element in the region of each opening to be closed of the gas generator. It is thus possible that, when gas generators are used which operate in a thrust-free manner in the free space when triggered, after the gas generator has been installed in the airbag module only outflow openings are opened which are effective in a desired direction, i.e. primarily in the direction of the airbag. Since the opposite outflow openings facing away from the airbag are closed, the annular gap for the deflection of the gas in the direction of the airbag can be omitted.

It is expedient that for each outflow opening to be closed, a closure element engaging in the latter is provided. In this case, the closure element preferably has the diameter of the outflow opening. However, a conical closure is also possible. In comparison to a sheet-like closure, in which the latter rests only on the outflow opening, there is the advantage of the seal being more secure.

In one embodiment, for each outflow opening to be closed, a separate closure stopper is provided as the closure element.

If the gas generator is fastened in a module housing, the latter has, in a further embodiment, a closure element in the region of each opening to be closed of the gas generator. In this embodiment, the closure element is therefore an integrated part of the module housing.

The invention can advantageously be used in particular when tubular gas generators are used, the module housing bearing tightly against the tubular gas generator in the region of each of the outflow openings to be closed of the same. It is expedient that the module housing has, on each opening to be closed, a cylindrical lug or a bead as the closure element.

In one embodiment, the module housing has, in the region of the gas generator, the shape of a half shell matched to the generator housing, and a retaining plate is provided in the module housing for fixing the gas generator.

When a cylindrical tubular gas generator is used, the module housing is designed as a cylindrical half shell which is assigned a cylindrical half shell as the retaining plate. It is expedient that the retaining plate has beads directed toward the gas generator, and that the retaining plate has at least one closure element, i.e. that each gas generator opening which is to be closed and is situated in the region of the retaining plate is assigned a closure element on the latter. It is furthermore expedient that a bead is provided in the retaining plate as the closure element.

The invention will be explained in more detail in exemplary embodiments with reference to drawings, in which:

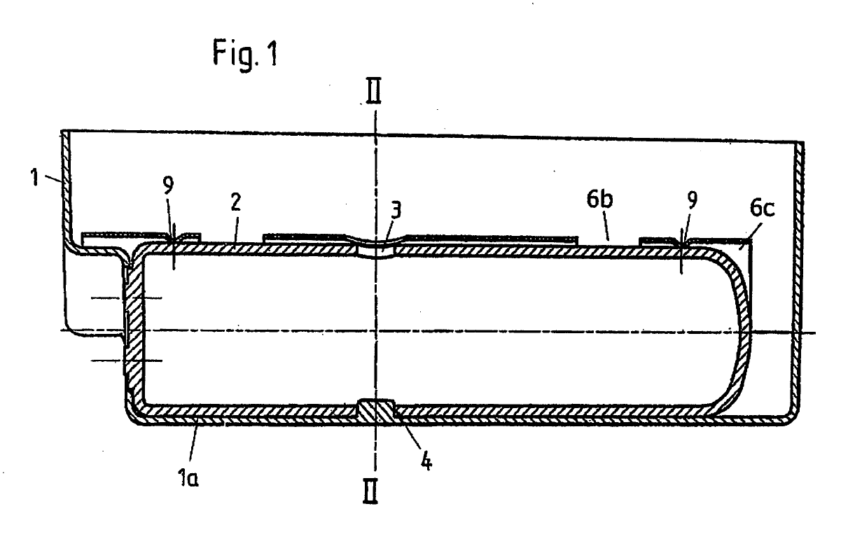

FIG. 1 shows a longitudinal section through a first embodiment;

FIG. 2 shows a cross section II-II of the arrangement according to FIG. 1;

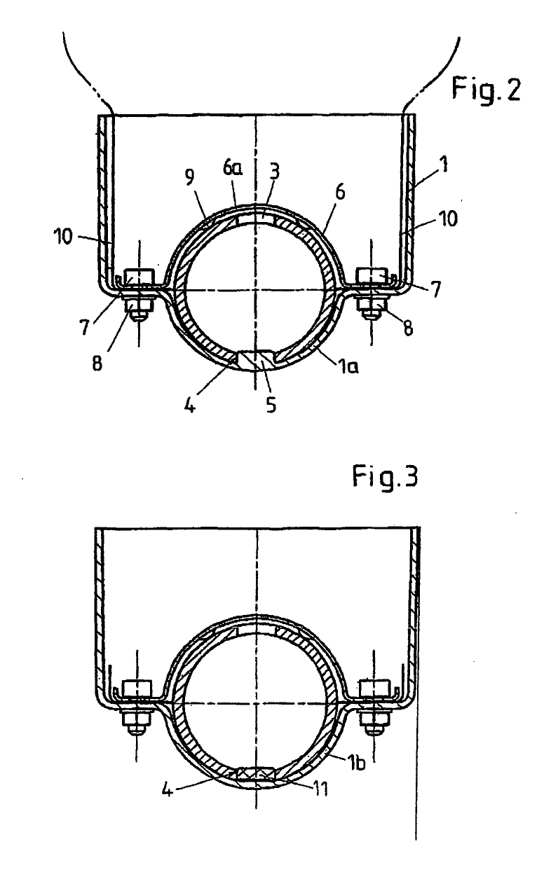

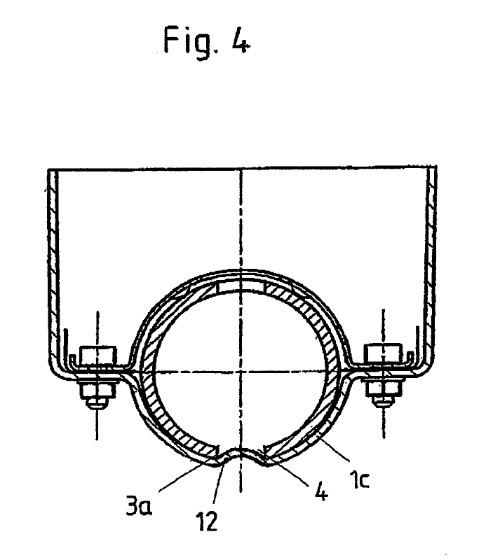

FIG. 3 shows a cross section through a second embodiment;

FIG. 4 shows a cross section through a third embodiment;

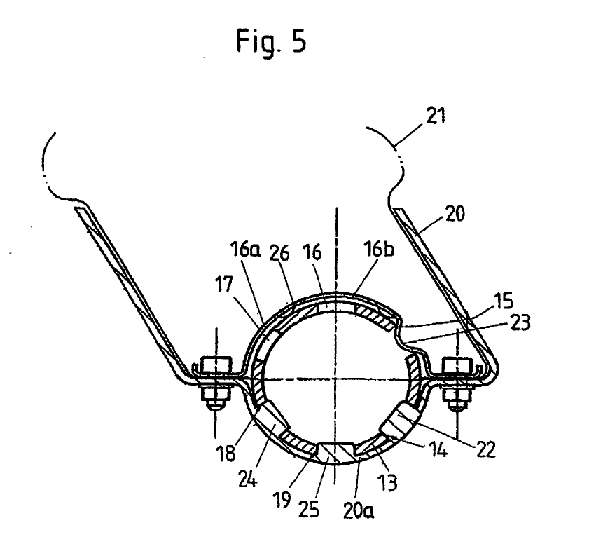

FIG. 5 shows a cross section through a fourth embodiment.

FIG. 1 illustrates a module housing 1 in which a tubular gas generator 2 is fastened. The latter has opposite outflow openings 3, 4, so that it operates in a thrust-free manner in the free space in the event of being inadvertently triggered.

The module housing is designed in the lower section as a half shell la which also has a cylindrical closure stopper 5 as the closure element for the outflow opening 4. Both have the same diameter with the necessary tolerances in order, on the one hand, to be able to introduce the closure stopper into the outflow opening and in order, on the other hand, to ensure sealing. As is apparent from FIGS. 1 and 2, the tubular gas generator 2 bears tightly against the half shell 1a. The fastening of the tubular gas generator 2 in the module housing 1 takes place by means of a retaining plate 6, which is connected to the module housing by means of screws 7 and nuts 8 and, in the process, presses the tubular gas generator 2 against the half shell 1a. The retaining plate 6 is likewise designed as a half shell. In this embodiment, the pressure against the tubular gas generator does not take place over the entire surface of the half shell, but rather via beads 9. An airbag 10 is also clamped between the module housing 1 and the retaining plate 6 by means of the screws 7 and the nuts 8, and is therefore fastened to the module housing 1.

It is apparent that, in this embodiment, most of the gases from the gas generator can flow through the outflow opening 3 and through an adjacent opening 6a in the retaining plate 6 only in the direction of the airbag 10. A small quantity of gas emerges via the gap caused by the beads 9, through relief openings 6b and end-side openings 6c likewise only in the direction of the airbag 10, that is apparent from FIGS. 1 and 2.

The embodiment of FIG. 3 differs from the embodiment of FIGS. 1 and 2 by the fact that a separate closure stopper 11 is provided as the closure element for the outflow opening 4 and a smooth half shell 1b. In this embodiment too, the high shell 1b, which bears tightly against the tubular gas generator 2, ensures that the closure stopper 11, after the gas generator has been triggered, is not pressed out of the outflow opening 4. The parts which are not provided with reference numbers correspond to the ones illustrated in FIGS. 1 and 2.

In this embodiment of FIG. 4, instead of a closure stopper a bead 12 is provided in a half shell 1c as the closure element. The bead does not fill the entire outflow opening 4, but rather the sealing takes place in the outer edge 3a.

In the case of the embodiment of FIG. 5, a tubular gas generator 13 is provided with six opposite outflow openings 14-19. The tubular gas generator is arranged in a module housing 20 oriented on one side. In order for the gases, after the gas generator has been triggered, to flow essentially in the direction of an airbag 21, the outflow openings 14, 15, 18 and 19 are closed. For this purpose, a lower half shell 20a of the module housing 20 is provided with closure stoppers 22, 24 and 25 which engage in the outflow openings 14, 18 and 19. Furthermore, a retaining plate 26 has a bead 23 for the closure of the outflow opening 15. The effect achieved by this is that most of the gases from the gas generator can flow, after the latter has been triggered, only out of the outflow openings 16 and 17 and through the adjacent openings 16a, b in the retaining plate 26 into the airbag.

1. An airbag module having a gas generator, in particular having a tubular gas generator, which has a plurality of outflow openings distributed over its circumference for the gases produced after it has been triggered, wherein at least one of the outflow openings in the gas generator can be closed during the installation or after the installation in the airbag module, and in that the gas generator is fastened in a module housing which has a closure element in the region of each opening to be closed of the gas generator.

2. The airbag module as claimed in claim 1, wherein for each outflow opening to be closed, a closure element engaging in the latter is provided.

3. The airbag module as claimed in claim 2, wherein the closure element has the diameter of the outflow openings.

4. The airbag module as claimed in claim 1, wherein for each outflow opening to be closed, a separate closure stopper is provided as the closure element.

5. The airbag module as claimed in claim 1, wherein a tubular gas generator is provided as the gas generator, the module housing bears tightly against the gas generator in the region of each of the outflow openings to be closed of the same.

6. The airbag module as claimed in claim 1, wherein the module housing has, on each opening to be closed, a cylindrical lug as the closure element.

7. The airbag module as claimed in claim 1, wherein the module housing has, on each opening to be closed, a bead as the closure element.

8. The airbag module as claimed in claim 1, wherein the module housing has, in the region of the gas generator, the shape of a half shell matched to the generator housing, and in that a retaining plate is provided for fixing the gas generator in the module housing.

9. The airbag module as claimed in claim 8, wherein the module housing, when a cylindrical tubular gas generator is used, is designed as a cylindrical half shell which is assigned a cylindrical half shell as the retaining plate.

10. The airbag module as claimed in claim 8, wherein the retaining plate has beads directed toward the gas generator.

11. The airbag module as claimed in claim 1, wherein the retaining plate has at least one closure element.

12. The airbag module as claimed in claim 11, wherein a bead is provided in the retaining plate as the closure element.
